(19) United States
(12) Patent Application Publication
(10) Pub. No.: US 2026/0264399 A1
(43) Pub. Date: Sep. 10, 2026

(54) LIQUID EJECTION BOARD, AND INKJET RECORDING APPARATUS

(71) Applicant: CANON KABUSHIKI KAISHA, Tokyo (JP)

(72) Inventor: YOHEI OSUKI, Chiba (JP)

(21) Appl. No.: 19/551,426

(22) Filed: Feb. 26, 2026

(30) Foreign Application Priority Data
Mar. 4, 2025 (JP) 2025-033596

(51) Int. Cl. B41J 2/14

(52) U.S. Cl. CPC B41J 2/14056; B41J 2/14072; B41J 2002/14185

(57) ABSTRACT

A liquid ejection board includes an ejection port from which liquid is ejected; a first electrothermal transducing element disposed to at least partially overlap the ejection port in plan view; a second electrothermal transducing element disposed without overlapping the ejection port in the planar view; a first electrode located between the first electrothermal transducing element and the ejection port and overlapping the first electrothermal transducing element in an electrode thickness direction; a second electrode located closer to the ejection port than the second electrothermal transducing element and overlapping the second electrothermal transducing element in the electrode thickness direction; an opposing electrode used in common as paired electrodes of the first and second electrodes and electrically connected via liquid; and a connection unit that electrically connects the first, second, and opposing electrodes to an outside.

### BACKGROUND

### Field of the Technology

The present disclosure relates to a liquid ejection board, and an inkjet recording apparatus.

### Description of the Related Art

An inkjet recording apparatus achieves recording by ejecting liquid from ejection ports formed on a recording head to cause the liquid to adhere to a recording material such as a paper sheet. The inkjet recording method, which is a method that uses an air bubble generated in the liquid by thermal energy to eject liquid, enables recording with high image quality at high speed.

Japanese Translation of PCT international Application Publication No. 2020-507497 discloses a print head (a recording head) provided with, on a wiring board, a drive unit that ejects ink via corresponding nozzles and a drive unit that circulates ink. In addition, Japanese Patent Laid-Open No. 2008-105364 discloses a technique of suppressing kogation.

### SUMMARY

A recording head may be provided with a liquid ejection board for ejecting liquid from ejection ports. In this case, there is a need for reducing the number of parts of the liquid ejection board.

A liquid ejection board according to an aspect of the present disclosure includes: an ejection port from which liquid is ejected; a first electrothermal transducing element disposed to at least partially overlap the ejection port in plan view; a second electrothermal transducing element disposed without overlapping the ejection port in the planar view; a first electrode located between the first electrothermal transducing element and the ejection port and overlapping the first electrothermal transducing element in an electrode thickness direction; a second electrode located closer to the ejection port than the second electrothermal transducing element and overlapping the second electrothermal transducing element in the electrode thickness direction; an opposing electrode used in common as a paired electrode of the first electrode and a paired electrode of the second electrode and electrically connected via liquid; and a connection unit that electrically connects the first electrode, the second electrode, and the opposing electrode to an outside.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram showing an example of the outer appearance configuration of an inkjet recording apparatus;

FIG. 2 is a block diagram showing an example of the configuration of a control system of the inkjet recording apparatus;

FIG. 3 is a diagram showing an example of a liquid ejection board;

FIG. 4 is a diagram showing an example of the cross-section of a part of the liquid ejection board in a first embodiment;

FIG. 5 is a diagram showing the cross-section taken along the V-V line in FIG. 4;

FIG. 6 is a diagram showing the cross-section taken along the VI-VI line in FIG. 4;

FIG. 7 is an enlarged view of the part surrounded by the dash-dot-dot line in FIG. 5;

FIG. 8 is an enlarged view of the part surrounded by the dash-dot-dot line in FIG. 6;

FIG. 9 is a diagram showing an example of a constant voltage waveform applied in an adhesion removal process;

FIG. 10 is a diagram showing an example of a pulsed voltage waveform applied in the adhesion removal process;

FIG. 11 is a diagram showing an example of another pulsed voltage waveform applied in the adhesion removal process;

FIG. 12 is a diagram showing a comparative example corresponding to FIG. 4;

FIG. 13 is a diagram showing the comparative example corresponding to FIG. 5;

FIG. 14 is a diagram showing the comparative example corresponding to FIG. 6;

FIG. 15 is a diagram showing the comparative example corresponding to FIG. 8;

FIG. 16 is a diagram showing an example of another arrangement of the electrodes in FIG. 4;

FIG. 17 is a diagram showing an example of another arrangement of the electrodes in FIG. 8; and

FIG. 18 is a diagram showing an example of the cross-section of a part of the liquid ejection board in a second embodiment.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. Incidentally, an identical reference numeral is assigned to an identical constituent and an explanation thereof is made.

In this specification, "recording" refers not only to forming meaningful information, such as characters or figures, but also to forming meaningless information. Further, it shall broadly refer to forming images, designs, patterns, and the like on a recording medium, or to processing the medium, regardless of whether they are actualized so as to be visually perceivable by humans.

In addition, "recording medium" in this specification shall refer to not only a paper sheet used in common recording apparatuses, but also broadly refer to cloth, a plastic film, a metal plate, glass, ceramics, wood, leather, and others capable of receiving ink.

Furthermore, "ink" in this specification should be broadly interpreted similar to the above definition of "recording". Therefore, it shall refer to liquid that, by being applied onto a recording medium, may be used for the formation of images, designs, patterns, and the like, for the processing of the recording medium, or for the processing of ink (e.g., the solidification or insolubilization of colorants in ink applied to the recording medium).

Furthermore, in this specification, "nozzle" shall collectively refer to an ejection port, a liquid channel communicating therewith, and an element that generates energy used to eject ink, unless otherwise specified.

A liquid ejection board used below does not refer to a simple substrate made of a silicon semiconductor, but to an arrangement in which elements, wires, and the like are provided. Furthermore, "on the board" not only refers to "on the liquid ejection board", but also even refers to the surface of the liquid ejection board and the inside of the liquid ejection board near the surface. In addition, "built-in" is not a term that refers to simply arranging separate individual elements on the surface of the substrate as separate members, but refers to integrally forming or manufacturing elements on the liquid ejection board through the process of manufacturing a semiconductor circuit or the like.

### First Embodiment

### Overview

A liquid ejection board includes an ejection port, a flow channel unit communicating with this ejection port, and an electrothermal transducing element that generates thermal energy used to eject ink. This electrothermal transducing element is coated with an insulating layer, such as silicon nitride, to ensure insulation with ink.

The electrothermal transducing element in ejecting liquid is exposed to high temperature and also subjected to combined loads. The combined loads include the impact associated with the collapse of an air bubble generated in ink, and the chemical action caused by ink. Therefore, the liquid ejection board may be provided with a protective layer for protecting the electrothermal transducing element. As being heated up to around 700°C and coming into contact with ink, the surface of this protective layer is required to have film properties excellent in heat resistance, mechanical properties, chemical stability, and alkali resistance.

In addition, pigment components such as coloring materials and additives contained in ink are decomposed at the molecular level by high-temperature heating, resulting in a phenomenon in which they are transformed into a poorly soluble substance called "kogation". In a case where this substance physically adheres to the protective layer, the heat conduction from the electrothermal transducing element to ink becomes uneven, resulting in a decrease in ink ejection speed, destabilization of bubbling, an increase in energy required for ejection, and the like. Thus, as in Japanese Patent Laid-Open No. 2008-105364, there has been proposed a technique for removing substances adhering to the protective layer from the protective layer. In this technique, an upper electrode and an opposing electrode electrically connected via liquid are provided, and these electrodes are supplied with power to cause electrochemical reaction. The upper electrode corresponds to the protective layer described above.

On the other hand, ink may be circulated for the purpose of ejecting air bubbles in a flow channel for ink, or suppressing thickening of ink near ejection ports. As means therefor, there is known a mechanism in which a circulating element that is a different electrothermal transducing element from an ejecting element, which is also an electrothermal transducing element for ejecting ink, is disposed in a flow channel communicating with an ejection port.

In a case of applying the above technique to this circulating element, it is necessary to dispose the upper and opposing electrodes for the ejecting element and the upper and opposing electrodes for the circulating element. In this case, there is a problem of an increased area of the liquid ejection board. An example to solve this problem will be described below.

### Configuration of Inkjet Recording Apparatus

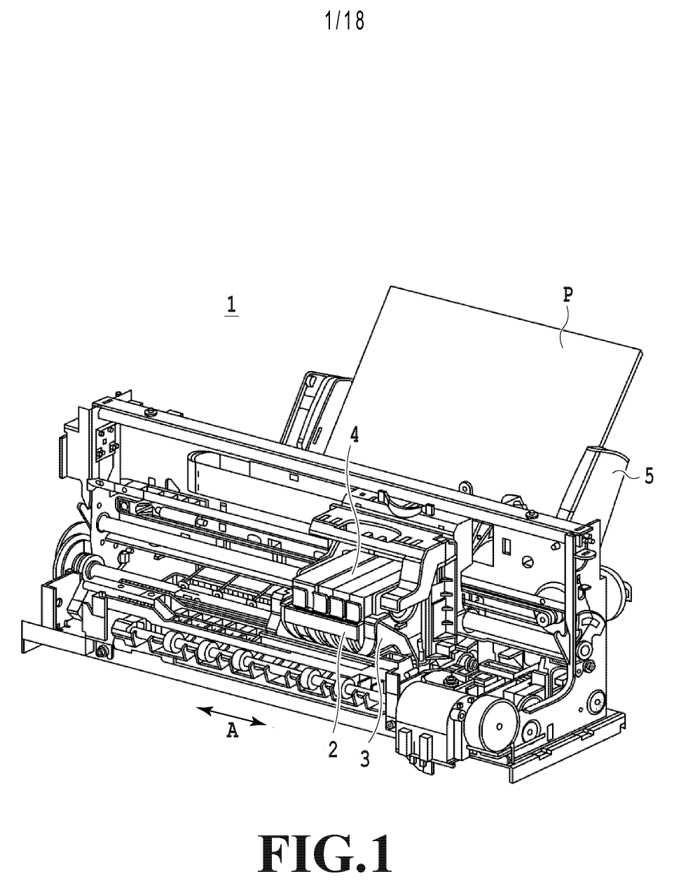

FIG. 1 is a diagram showing an example of the outer appearance configuration of an inkjet recording apparatus 1. The inkjet recording apparatus 1 performs recording on a recording medium P by causing a recording head 2 to scan and eject ink. The inkjet recording apparatus 1 records an image on the recording medium P by alternately repeating the recording operation and the feeding operation. The recording operation is an operation that includes at least one of moving the recording head 2 in the main scanning direction and ejecting ink from the recording head 2. The feeding operation is an operation of feeding the recording medium P in the sub-scanning direction. The main scanning direction and the sub-scanning direction cross each other. In the example in FIG. 1, the main scanning direction is the direction A.

The recording head 2 is mounted on a carriage 3. The carriage 3 is provided movably in the main scanning direction A. The recording head 2 mounted on the carriage 3 can reciprocally move in the main scanning direction A. An ink tank 4 is also mounted on the carriage 3. The ink tank 4 stores ink. The recording head 2 ejects ink supplied from the ink tank 4. The recording medium P is fed by a feed mechanism 5.

In the example shown in FIG. 1, the inkjet recording apparatus 1 is capable of color recording. For example, four ink cartridges are used as the ink tank 4. A first ink cartridge contains magenta (M) ink. A second ink cartridge contains cyan (C) ink. A third ink cartridge contains yellow (Y) ink. A fourth ink cartridge contains black (K) ink. Each ink cartridge is removable from the carriage 3.

In the example shown in FIG. 1, the recording method of the inkjet recording apparatus 1 is the serial method, whereas it may be the full-line method. The serial method is a method of recording an image on the recording medium P by alternately repeating the recording operation and the feeding operation. The full-line method uses a recording head that extends in the direction crossing the feed direction of the recording medium P to record an image while continuously feeding the recording medium P.

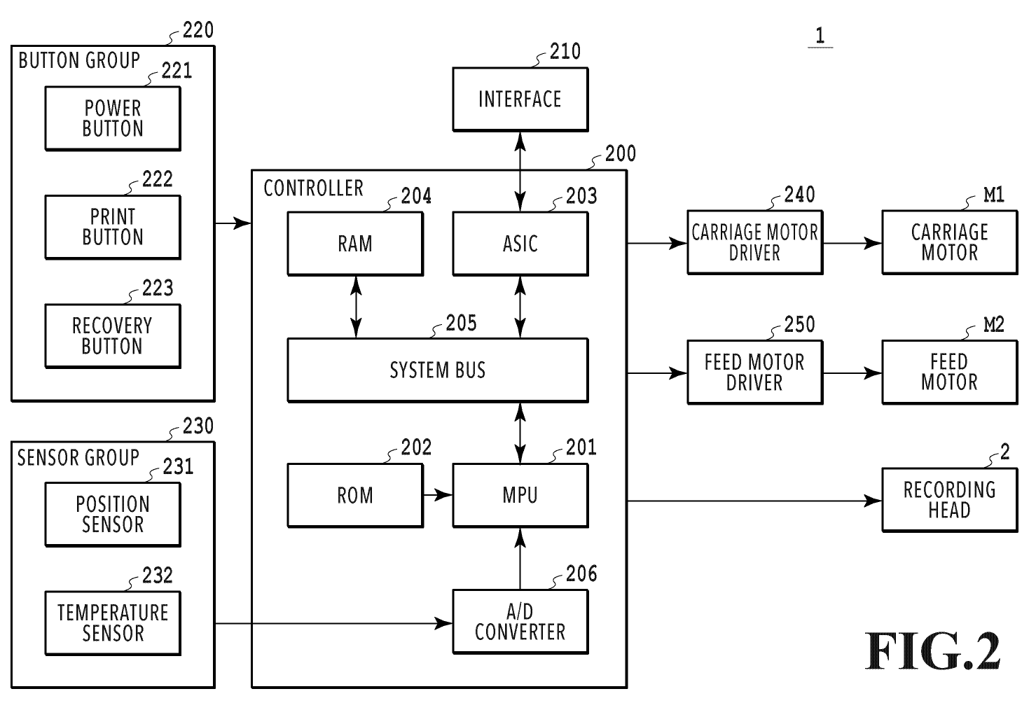

FIG. 2 is a block diagram showing an example of the configuration of a control system of the inkjet recording apparatus 1. The inkjet recording apparatus 1 includes a controller 200. The controller 200 is a control unit that performs control for implementing various functions of the inkjet recording apparatus 1. The controller 200 includes an MPU 201, a ROM 202, an application specific integrated circuit 203, a RAM 204, a system bus 205, and an A/D converter 206.

The MPU 201 is a processor that performs various processes by executing programs or activating hardware. A program is executed by deploying the program on the RAM 204. The ROM 202 stores various types of data. For example, programs, tables, and setting values corresponding to control sequences are stored therein. The RAM 204 is used as a work area for the MPU 201. The system bus 205 is a data transmission path. The MPU 201, the application specific integrated circuit 203, the RAM 204, and the like are connected to the system bus 205. The A/D converter 206 converts an analog signal into a digital signal and outputs the converted digital signal to the MPU 201.

The application specific integrated circuit 203 may be abbreviated as ASIC. The application specific integrated circuit 203 performs a specific process. For example, a process of generating a carriage control signal, a feed control signal, and a head control signal is performed. The carriage control signal is a signal for controlling a carriage motor M1 that drives the carriage 3. The feed control signal is a signal for controlling a feed motor M2 that drives the feed mechanism 5. The head control signal is a signal for controlling the movement of the recording head 2 and the driving of the electrothermal transducing element included in the recording head 2. The generated carriage control signal, feed control signal, and head control signal are output from the controller 200.

An interface 210 is connected to the controller 200. The interface 210 sends and receives image data, commands, status, and the like between one or more pieces of external equipment and the controller 200. A host apparatus (not shown), which is one of the pieces of external equipment, is connected to the controller 200 via the interface 210. The host apparatus feeds image data to be printed by the inkjet recording apparatus 1 to the controller 200 via the interface 210.

In addition, a button group 220 and a sensor group 230 are connected to the controller 200. The button group 220 includes a power button 221, a print button 222, and a recovery button 223. Various signals output from the button group 220 are output to the controller 200. The sensor group 230 includes a position sensor 231 and a temperature sensor 232. Various signals output from the sensor group 230 are output to the A/D converter 206 of the controller 200.

In addition, a carriage motor driver 240 is connected to the controller 200. The carriage motor driver 240 controls the carriage motor M1 based on the carriage control signal output from the controller 200 to move the carriage 3.

In addition, a feed motor driver 250 is connected to the controller 200. The feed motor driver 250 controls the feed motor M2 based on the feed control signal output from the controller 200 to cause the feed mechanism 5 to feed the recording medium P.

In addition, the recording head 2 is connected to the controller 200. The recording head 2 performs a recording operation based on the head control signal output from the controller 200. Note that a user interface (not shown) is also connected to the controller 200. The user interface is, for example, a touch panel with a liquid crystal layer and a touch sensor layer.

### Configuration of Liquid Ejection Board

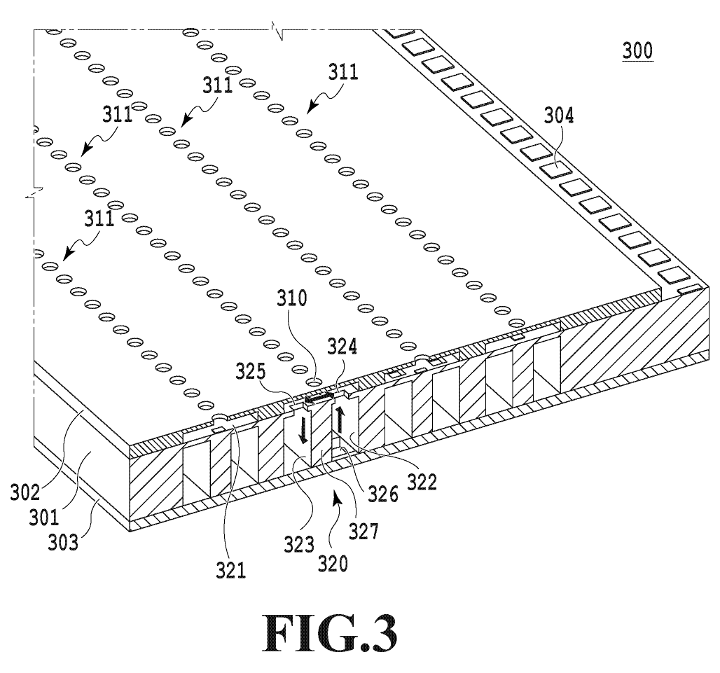

FIG. 3 is a diagram showing an example of a liquid ejection board 300. The liquid ejection board 300 is included in the recording head 2. Specifically, the liquid ejection board 300 is integrally attached to the head body to form the recording head 2. The liquid ejection board 300 includes a main plate 301, a nozzle plate 302, and a cover plate 303. The main plate 301 is laminated on the cover plate 303, and the nozzle plate 302 is laminated on the main plate 301. The main plate 301, the nozzle plate 302, and the cover plate 303 are formed integrally.

The surface of the main plate 301 on which the nozzle plate 302 is laminated has a region where the nozzle plate 302 is not laminated. This region is provided with a plurality of pads 304. The plurality of pads 304 are a connection unit that electrically connects the liquid ejection board 300 to the outside. The liquid ejection board 300 is supplied with power, data, and the like via the pads 304.

A plurality of ejection ports 310 are formed on the liquid ejection board 300. Specifically, the plurality of ejection ports 310 are formed in the nozzle plate 302. Each ejection port 310 is disposed in one of a plurality of ejection port rows 311. An ejection port row 311 is a group of ejection ports 310 arranged in one direction at intervals. The total number of two or more ejection ports 310 constituting each ejection port row 311 corresponds to the number of ejection ports 310 formed in the nozzle plate 302. Each ejection port 310 extends from the ejection surface of the liquid ejection board 300 to a flow channel unit 320 formed inside the liquid ejection board 300. Note that the ejection surface of the liquid ejection board 300 is the opposite surface of the surface of the nozzle plate 302 facing the main plate 301.

The flow channel unit 320 is a part of a flow channel formed in the recording head 2. The other part of the flow channel is formed in the head body. The flow channel unit 320 is formed for each ejection port row 311. The flow channel unit 320 includes a liquid chamber 321, a liquid supply channel 322, a liquid collection channel 323, a plurality of supply ports 324, a plurality of collection ports 325, an inlet port 326, and an outlet port (not shown).

The liquid chamber 321 is formed in the nozzle plate 302 along the extending direction of the ejection port row 311. The liquid chamber 321 communicates with each ejection port 310 constituting the ejection port row 311. The liquid supply channel 322 and the liquid collection channel 323 are formed in the main plate 301 along the extending direction of the ejection port row 311. The liquid supply channel 322 and the liquid collection channel 323 are isolated by a nozzle wall 327. The nozzle wall 327 is a part constituting the main plate 301. The plurality of supply ports 324 are arranged between the liquid chamber 321 and the liquid supply channel 322 along the extending direction of the ejection port row 311 at intervals. Each supply port 324 is a communicating hole (a first communicating hole) communicating the liquid chamber 321 with the liquid supply channel 322. The plurality of collection ports 325 are arranged between the liquid chamber 321 and the liquid collection channel 323 along the extending direction of the ejection port row 311 at intervals. Each collection port 325 is a communicating hole (a second communicating hole) communicating the liquid chamber 321 with the liquid collection channel 323. The inlet port 326 is a hole for causing ink to flow in from the head body and is formed in the cover plate 303. The outlet port (not shown) is a hole for causing ink to flow out to the head body and is formed in the cover plate 303.

Ink flows from the head body to the liquid supply channel 322 via the inlet port 326. The ink flowing into the liquid supply channel 322 is supplied to the liquid chamber 321 via the supply port 324. The ink supplied to the liquid chamber 321 flows to the liquid collection channel 323 via the collection port 325. The ink flowing into the liquid collection channel 323 flows out to the head body via the outlet port (not shown). The ink flowing out to the head body again flows into the liquid supply channel 322 via the inlet port 326. In this way, in the liquid ejection board 300, the flow channel unit 320, which is a part of the flow channel for circulating ink formed on the recording head 2, is formed inside the liquid ejection board 300.

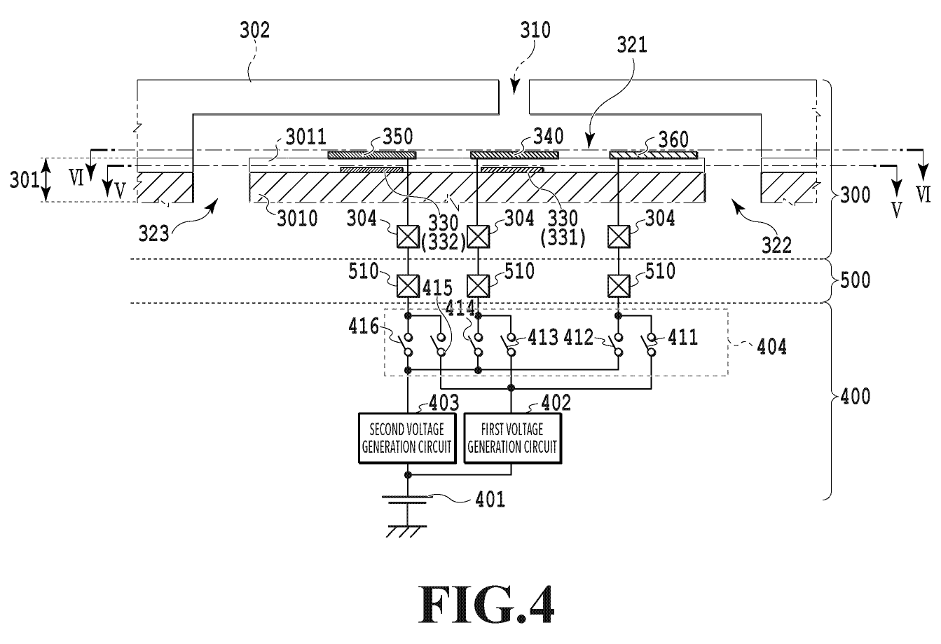

FIG. 4 is a diagram showing an example of the cross-section of a part of the liquid ejection board 300 in a first embodiment. Specifically, FIG. 4 shows a part of the cross-section of the liquid ejection board 300 and a circuit unit 400 connected to the liquid ejection board 300. The circuit unit 400 is, for example, housed in the enclosure of the inkjet recording apparatus 1.

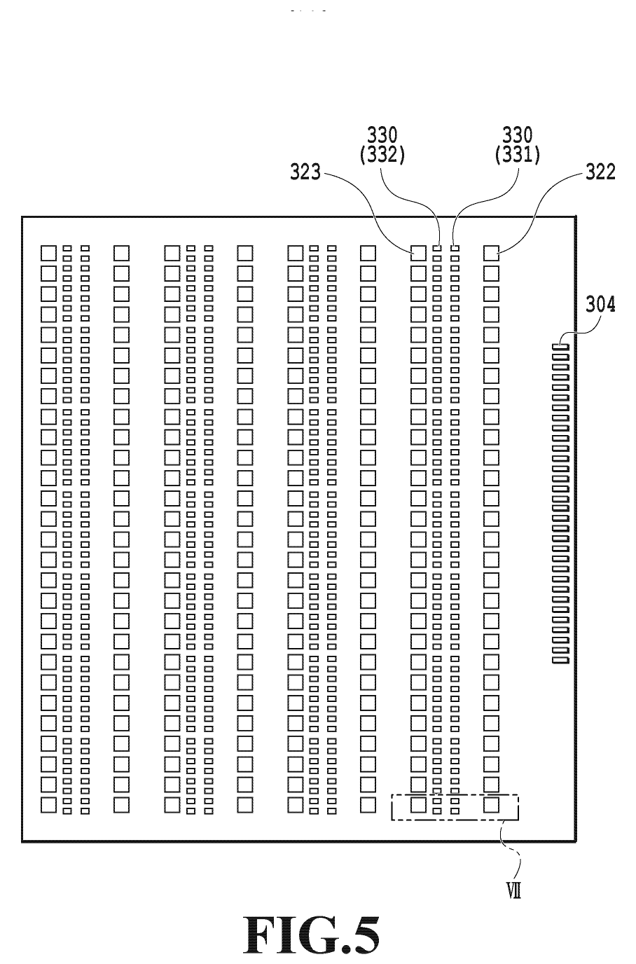

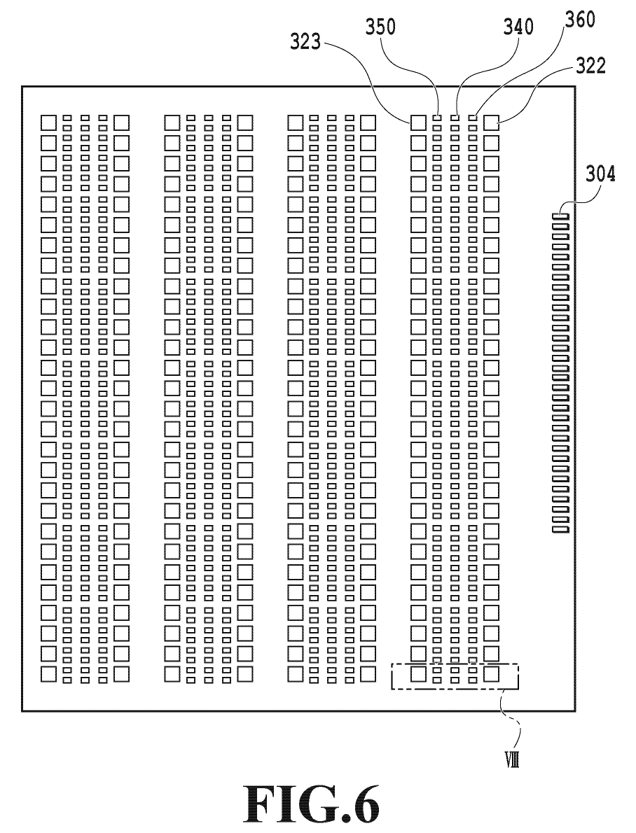

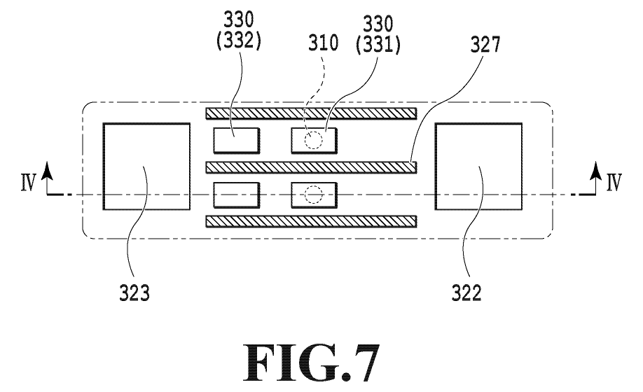

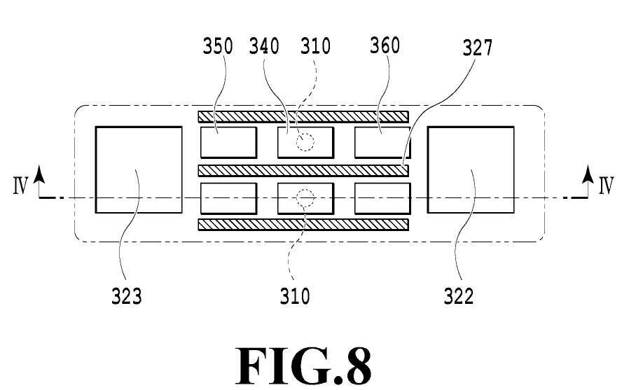

FIG. 5 is a diagram showing the cross-section taken along the V-V line in FIG. 4. FIG. 6 is a diagram showing the cross-section taken along the VI-VI line in FIG. 4. FIG. 7 is an enlarged view of the part surrounded by the dash-dot-dot line in FIG. 5. FIG. 8 is an enlarged view of the part surrounded by the dash-dot-dot line in FIG. 6. A part of the cross-section taken along the IV-IV lines in FIGS. 7 and FIG. 8 corresponds to the part of the cross-section of the liquid ejection board 300 shown in FIG. 4.

In the example in FIGS. 5 and FIG. 6, a plurality of elements is arranged corresponding to magenta (M), cyan (C), yellow (Y), and black (K) inks in one direction. The following will describe the plurality of elements using FIGS. 4 to FIG. 8.

As shown in FIG. 4, the liquid ejection board 300 is provided with a plurality of electrothermal transducing elements 330. Some of the plurality of electrothermal transducing elements 330 function as ejecting elements 331 for ejecting ink. The others of the plurality of electrothermal transducing elements 330 function as circulating elements 332 for circulating ink.

As shown in FIGS. 5 and FIG. 7, the ejecting elements 331 are arranged for each ejection port row 311 along the extending direction of the ejection port row 311 at intervals. As shown in FIG. 7, an ejecting element 331 corresponds to each of the plurality of ejection ports 310. The ejecting element 331 is disposed to overlap the ejection port 310 in plan view from a first direction. The first direction corresponds to the lamination direction, which is the direction in which the nozzle plate 302 is laminated on the main plate 301. The ejecting element 331 is located apart from the ejection port 310 in the lamination direction. Note that in the example of FIG. 7, the ejecting element 331 is disposed to overlap the entire ejection port 310 in the planar view from the first direction, whereas it may also be disposed to overlap at least part of the ejection port 310.

As shown in FIG. 4, the ejecting element 331 is disposed inside the main plate 301 and insulated from ink. In the example in FIG. 4, the ejecting element 331 is disposed on the surface of a body layer 3010 constituting the main plate 301 and is covered with an insulating film 3011 constituting the main plate 301. Materials for the insulating film 3011 include, for example, silicon nitride (SiN).

The ejecting element 331 is supplied with a first ejection control signal via electrical wiring provided on the main plate 301 (not shown). The first ejection control signal is a pulse signal for turning on or off the power supply to the ejecting element 331. The first ejection control signal is generated by the controller 200, a controller provided in the head body of the recording head 2, or the like. The ejecting element 331 instantaneously heats the ink in the liquid chamber based on the first ejection control signal to eject the ink from the ejection port 310. In this case, the pressure caused by the expansion of an air bubble generated in response to the heating is the force that causes the ink to be ejected.

As shown in FIGS. 5 and FIG. 7, the circulating elements 332 are arranged for each ejection port row 311 along the extending direction of the ejection port row 311 at intervals. As shown in FIG. 7, a circulating element 332 is disposed in the vicinity of each ejecting element 331. The circulating element 332 is disposed without overlapping the ejection port 310 in the planar view from the first direction. In other words, the circulating element 332 is not located in the first direction passing through the ejection port 310.

As shown in FIG. 4, the circulating element 332 is disposed inside the main plate 301 and insulated from ink. In the example of FIG. 4, the circulating element 332 is disposed on the surface of the body layer 3010 and is covered with the insulating film 3011, which is common to the ejecting element 331.

The circulating element 332 is supplied with a second ejection control signal via electrical wiring provided on the main plate 301 (not shown). The second ejection control signal is a pulse signal for turning on or off the power supply to the circulating element 332. The second ejection control signal is generated by the controller 200, the controller provided in the head body of the recording head 2, or the like. The circulating element 332 instantaneously heats the ink in the liquid chamber based on the second ejection control signal and causes the ink to flow. In this case, the bias of the flow resistance based on an air bubble generated in response to the heating and the collapse of the air bubble is the force that causes the ink to flow. The power supplied to the circulating element 332 is different from the power supplied to the ejecting element 331. Specifically, the power supplied to the circulating element 332 is lower than the power supplied to the ejecting element 331.

As shown in FIGS. 6 and FIG. 8, in the liquid ejection board 300, first electrodes 340 are provided for each ejection port row 311 along the extending direction of the ejection port row 311 at intervals. As shown in FIG. 8, a first electrode 340 corresponds to each of the plurality of ejection ports 310. The first electrode 340 is disposed to overlap an ejection port 310 in the planar view from the first direction.

As shown in FIG. 4, the first electrode 340 is disposed on the surface of the main plate 301 in the liquid chamber and is in contact with the ink in the liquid chamber. The first electrode 340 is located between the ejection port 310 and the ejecting element 331 in the first direction. The first electrode 340 is disposed to cover the ejecting element 331 which is located apart from the first electrode 340 in the first direction.

The first electrode 340 is a protective member that protects the ejecting element 331, and has cavitation resistance. Cavitation resistance refers to resistance to shock waves generated in a case where an air bubble generated in ink collapse. The first electrode 340 is also a member for removing adhered substances. An adhered substance refers to a substance that adheres to an electrode. This substance is specifically a poorly soluble substance resulting from the decomposition of pigment components in ink.

To have cavitation resistance and enable the removal of adhered substances, a main material such as a metal is used for the first electrode 340. Specific examples of the metal include iridium (Ir) and ruthenium (Ru), whereas other metals or alloys may be used. Note that the first electrode 340 may be made of the main material in its entirety. Alternatively, the first electrode 340 may consist of an electrode body and a film formed of the main material on the surface of the electrode body.

As shown in FIGS. 6 and FIG. 8, in the liquid ejection board 300, second electrodes 350 are provided for each ejection port row 311 along the extending direction of the ejection port row 311 at intervals. As shown in FIG. 8, a second electrode 350 is disposed in the vicinity of each first electrode 340. The second electrode 350 is disposed in the vicinity of the first electrode 340 without overlapping the ejection port 310 in the planar view from the first direction.

As shown in FIG. 4, the second electrode 350 is disposed on the surface of the main plate 301 in the liquid chamber and is in contact with the ink in the liquid chamber. The second electrode 350 is located closer to the ejection port 310 than the circulating element 332 in the first direction. The second electrode 350 is apart from the first electrode 340 in the direction crossing (orthogonal to) the first direction, and is located downstream of the ink from the first electrode 340. The second electrode 350 is disposed to overlap the circulating element 332 in the first direction. The second electrode 350 is disposed to cover the circulating element 332 which is located apart from the second electrode 350 in the first direction.

The second electrode 350 is a protective member that protects the circulating element 332, and has cavitation resistance. In addition, the second electrode 350 is also a member for removing adhered substances. To have cavitation resistance and enable the removal of adhered substances, a main material such as a metal is used for the second electrode 350. The main material of the second electrode 350 may be the same as or different from the main material of the first electrode 340. In addition, the second electrode 350 may be made of the main material in its entirety. Alternatively, the second electrode 350 may consist of an electrode body and a film formed of the main material on the surface of the electrode body.

As shown in FIGS. 6 and FIG. 8, in the liquid ejection board 300, opposing electrodes 360 are provided for each ejection port row 311 along the extending direction of the ejection port row 311 at intervals. As shown in FIG. 8, an opposing electrode 360 is disposed in the vicinity of each first electrode 340. Specifically, the opposing electrode 360 is located upstream of the ink from the first electrode 340 without overlapping the ejection port 310 in the planar view from the first direction. The opposing electrode 360 is lined up in the direction of ink flow together with the first electrode 340 and the second electrode 350.

As shown in FIG. 4, the opposing electrode 360 is disposed on the surface of the main plate 301 in the liquid chamber and is in contact with the ink in the liquid chamber. The opposing electrode 360 is commonly used as a paired electrode of the first electrode 340 and a paired electrode of the second electrode 350, and is electrically connected via ink. The first electrode 340 is disposed between the opposing electrode 360 and the second electrode 350. The opposing electrode 360 is not a protective member unlike the first electrode 340 and the second electrode 350. Therefore, a different material from the material of the first electrode 340 and the material of the second electrode 350 can be used for the opposing electrode 360.

In a case of using the same material for the opposing electrode 360 as the material for the first electrode 340 and the second electrode 350, the opposing electrode 360, the first electrode 340, and the second electrode 350 can be formed in a common layer. In the example of FIG. 4, the opposing electrode 360, the first electrode 340, and the second electrode 350 are formed in a common layer. In this case, the electrodes can be formed in the same process.

Note that the opposing electrode 360, the first electrode 340, and the second electrode 350 are not electrically connected to any of the plurality of electrothermal transducing elements 330. In addition, in the example of FIG. 4, while the opposing electrode 360, the first electrode 340, and the second electrode 350 are not disposed without being offset from each other in the plate thickness direction of the main plate 301, they may be offset from each other. For example, the opposing electrode 360 can be disposed at a position offset from the first electrode 340 and the second electrode 350 in the plate thickness direction of the main plate 301. In this case, the first electrode 340 and the second electrode 350 may be formed in a common layer.

### Circuit Configuration

A configuration of the circuit unit 400 will be described next using FIG. 4. The circuit unit 400 is a circuit unit for generating a potential difference between the first electrode 340 and the opposing electrode 360 and between the second electrode 350 and the opposing electrode 360.

The circuit unit 400 is electrically connected to the first electrode 340, the second electrode 350, and the opposing electrode 360. For example, the pads 304 provided on the liquid ejection board 300 are connected to head pads 510, which are pads provided on a head board 500, via electrical wiring (not shown) provided on the main plate 301. The head pads 510 are electrically connected to the circuit unit 400 in a case where the recording head 2 is mounted on the carriage 3.

Note that the head board 500 is a board of the head body on which the liquid ejection board 300 is provided. The head board 500 and the liquid ejection board 300 are included in the recording head 2. A circulation path, which is a flow channel through which ink circulates, is formed in the recording head 2. This circulation path includes a flow channel unit (not shown) formed in the head board 500 and the flow channel unit 320 formed in the liquid ejection board 300 described above.

The circuit unit 400 includes a power supply unit 401, a first voltage generation circuit 402, a second voltage generation circuit 403, and a switching unit 404. In the example of FIG. 4, while the first voltage generation circuit 402, the second voltage generation circuit 403, and the switching unit 404 are provided in the circuit unit 400 of the inkjet recording apparatus 1, the present disclosure is not limited to this. For example, the first voltage generation circuit 402, the second voltage generation circuit 403, and the switching unit 404 may be provided in the recording head 2. Alternatively, the first voltage generation circuit 402, the second voltage generation circuit 403, and the switching unit 404 may be provided in the liquid ejection board 300.

The power supply unit 401 may be the same as or different from the power supply circuit of the inkjet recording apparatus 1, which powers the controller 200 and the like. The first voltage generation circuit 402 and the second voltage generation circuit 403 are circuits that generate voltage based on power supplied from the power supply unit 401. The voltage generated by the first voltage generation circuit 402 is denoted by V1 [V]. The voltage generated by the second voltage generation circuit 403 is denoted by V2 [V]. V1 is larger than V2. The first voltage generation circuit 402 may vary the magnitude of the voltage to be generated. In this case, the first voltage generation circuit 402 adjusts the output voltage based on a signal output from the controller 200 or the like. Similarly, the second voltage generation circuit 403 may vary the magnitude of the voltage to be generated.

The switching unit 404 is equipment that is switchable between on and off of the application of a potential difference. The application of a potential difference is set to on or off based on an output signal from the controller 200. The controller 200 may control the switching unit 404 to cause a potential difference between the electrodes. In this embodiment, "between the electrodes" refers to "between at least one of the first electrode 340 and the second electrode 350 and the opposing electrode 360".

In the example of FIG. 4, the switching unit 404 includes a first switching device 411, a second switching device 412, and a third switching device 413. Additionally, the switching unit 404 includes a fourth switching device 414, a fifth switching device 415, and a sixth switching device 416.

In a case where the third switching device 413 and the second switching device 412 are set to on and the other switching devices are set to off, a potential difference occurs between the first electrode 340 and the opposing electrode 360. In this case, the potential of the first electrode 340 is higher than that of the opposing electrode 360. In addition, in a case where the fourth switching device 414 and the first switching device 411 are set to on and the other switching devices are set to off, a potential difference also occurs between the first electrode 340 and the opposing electrode 360. In this case, the potential of the first electrode 340 is lower than that of the opposing electrode 360.

In a case where the fifth switching device 415 and the second switching device 412 are set to on and the other switching devices are set to off, a potential difference occurs between the second electrode 350 and the opposing electrode 360. In this case, the potential of the second electrode 350 is higher than that of the opposing electrode 360. In addition, in a case where the sixth switching device 416 and the first switching device 411 are set to on and the other switching devices are set to off, a potential difference occurs between the second electrode 350 and the opposing electrode 360. In this case, the potential of the second electrode 350 is lower than that of the opposing electrode 360.

In a case where the fifth switching device 415, the third switching device 413, and the second switching device 412 are set to on and the other switching devices are set to off, a potential difference occurs between the electrodes. "Between the electrodes" refers to "between the first electrode 340 and the opposing electrode 360" and "between the second electrode 350 and the opposing electrode 360". On the other hand, in a case where the sixth switching device 416, the fourth switching device 414, and the first switching device 411 are set to on and the other switching devices are set to off, a potential difference also occurs between the electrodes.

### Control Processes

This embodiment can perform an adhesion suppression process (a first process) and an adhesion removal process (a second process) as control processes.

The adhesion suppression process (first process) will be described first. The adhesion suppression process is a process of suppressing the adhesion of poorly soluble substances to the first electrode 340 and the second electrode 350. This adhesion suppression process is performed while the electrothermal transducing elements 330 are heated. That is, in a case where the ejecting element 331 and the circulating element 332 are supplied with power, the controller 200 controls the switching unit 404 so that a potential difference occurs. In this case, for example, the voltage applied to the first electrode 340 and the second electrode 350 is set to 0 [V], and the voltage applied to the opposing electrode 360 is set to 1 [V]. In a case where such a potential difference occurs, the pigment components of the ink are repelled by the first electrode 340 and the second electrode 350 and attracted to the opposing electrode 360. This suppresses the generation of poorly soluble substances at the first electrode 340 and the second electrode 350, and suppresses the adhesion of poorly soluble substances to the first electrode 340 and the second electrode 350. As another example, the voltage applied to the first electrode 340 and the second electrode 350 may be a negative voltage, such as -0.3 V.

The adhesion removal process (second process) will be described next. The adhesion removal process is a process for removing adhered substances adhering to an electrode from the electrode. This adhesion removal process is performed while the electrothermal transducing elements 330 are not heated. That is, in a case where the ejecting element 331 and the circulating element 332 are not supplied with power, the controller 200 controls the switching unit 404 so that a potential difference occurs. In this case, for example, the voltage applied to the first electrode 340, the second electrode 350, or both is set to 5 [V], and the voltage applied to the opposing electrode 360 is set to 0 [V]. In a case where such a potential difference occurs, at least one of the first electrode 340 and the second electrode 350 becomes the anode, and the opposing electrode 360 becomes the cathode. In the anode, the adhered substances adhering to the electrode surface that is in contact with the ink elute the electrode surface by electrochemical reaction. This peels and removes the adhered substances from the electrode.

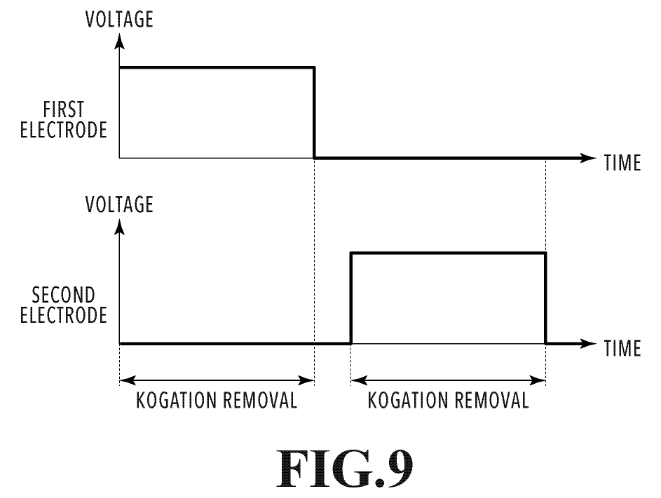

FIG. 9 is a diagram showing an example of a constant voltage waveform applied in the adhesion removal process. In the example shown in FIG. 9, at first, a constant voltage is applied to the first electrode 340 and the opposing electrode 360 is set to 0 [V]. This elutes the first electrode 340 to remove the adhered substances from the first electrode 340. After a predetermined amount of time has elapsed since the application of the voltage to the first electrode 340, the first electrode 340 is set to 0 [V] and a constant voltage is applied to the second electrode 350. This elutes the second electrode 350 to remove the adhered substances from the second electrode 350. In a case where a predetermined amount of time has elapsed since the application of the voltage to the second electrode 350, the second electrode 350 is set to 0 [V].

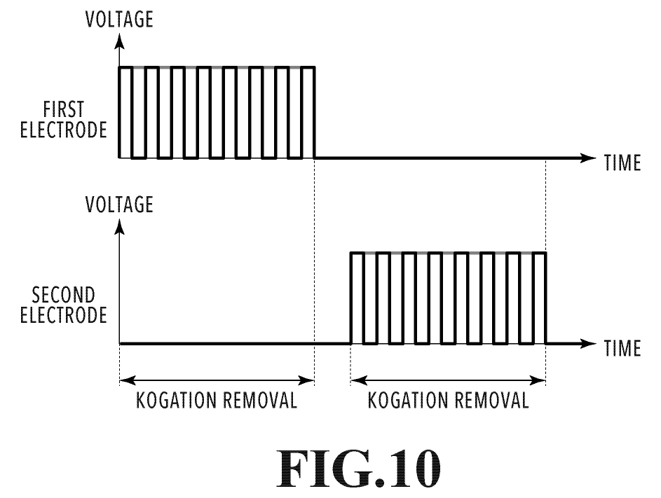

FIG. 10 is a diagram showing an example of a pulsed voltage waveform applied in the adhesion removal process. In the example shown in FIG. 10, at first, a pulsed voltage is applied to the first electrode 340, and the opposing electrode 360 is set to 0 [V]. After a predetermined amount of time has elapsed since the application of the pulsed voltage to the first electrode 340, the first electrode 340 is set to 0 [V] and the pulsed voltage is applied to the second electrode 350. In a case where a predetermined amount of time has elapsed since the application of the voltage to the second electrode 350, the second electrode 350 is set to 0 [V].

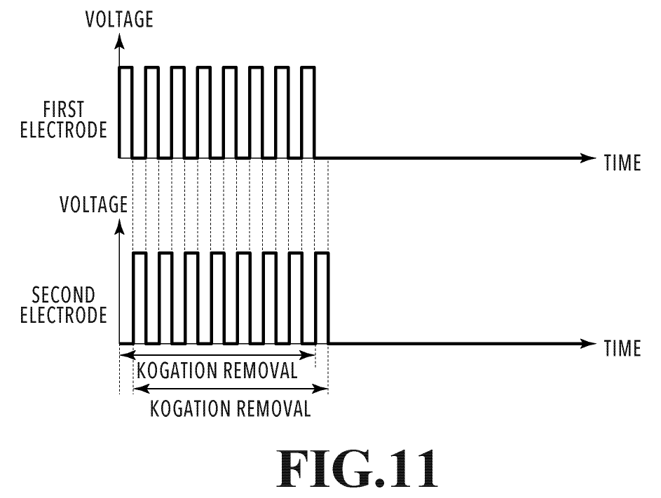

FIG. 11 is a diagram showing an example of another pulsed voltage waveform applied in the adhesion removal process. In the example shown in FIG. 11, the opposing electrode 360 is set to 0 [V], and a pulsed voltage is alternately applied to the first electrode 340 and the second electrode 350. After a predetermined amount of time has elapsed since the application of the voltage, the application of the voltage is stopped. That is, the occurrence of the potential difference between the first electrode 340 and the opposing electrode 360 and the occurrence of the potential difference between the second electrode 350 and the opposing electrode 360 are repeated alternately until the predetermined period elapses.

In the adhesion removal process, the potential difference between the first electrode 340 and the opposing electrode 360 may be different from the potential difference between the second electrode 350 and the opposing electrode 360. This is because the amount of adhered substance adhering to the first electrode 340 tend to be different from the amount of adhered substance adhering to the second electrode 350. Specifically, this trend is due to the difference in at least one of the element configuration and driving conditions between the ejecting element 331, which emits heat to be added to the first electrode 340, and the circulating element 332, which emits heat to be added to the second electrode 350. The element configuration is, for example, the area of the element. The driving conditions are, for example, the magnitude of the voltage or the pulse width. Note that at least one of the magnitude and time of the potential difference applied between the first electrode 340 and the opposing electrode 360 can be greater than that of the potential difference applied between the second electrode 350 and the opposing electrode 360. This is because the power supplied to the ejecting element 331 is greater than the power supplied to the circulating element 332.

Here, an example is given for making the potential difference between the first electrode 340 and the opposing electrode 360 different from the potential difference between the second electrode 350 and the opposing electrode 360. For example, the magnitude of the voltage applied to the first electrode 340 is made different from the magnitude of the voltage applied to the second electrode 350. Alternatively, in a case where the magnitudes of the voltages applied to the first electrode 340 and the second electrode 350 are the same constant voltage, the application time of the voltage to the first electrode 340 is made different from the application time of the voltage to the second electrode 350. Alternatively, in a case where the voltages applied to the first electrode 340 and the second electrode 350 are pulsed voltages, those pulsed voltages are made different. Specifically, the first electrode 340 and the second electrode 350 are made different from each other in at least one of the pulse width, pulse frequency, pulse duty, and number of pulses.

Note that although there is almost no adhesion of poorly soluble substances to the opposing electrode 360, the adhesion removal process may be performed. For example, the opposing electrode 360 is set to 5 [V], and the first electrode 340 is set to 0 [V]. In this case, the opposing electrode 360 becomes the anode, the first electrode 340 becomes the cathode, and the adhered substances are removed from the opposing electrode 360. In a case where the adhesion removal process is not performed on the opposing electrode 360, the opposing electrode 360 can also be connected to the ground of the liquid ejection board 300.

In addition, in the adhesion removal process, the bubbles generated by electrolysis of water may be removed. For example, a suction machine is provided in the liquid chamber 321 or the like, and the suction machine is driven in a case where a potential difference is applied. This drive signal is supplied from the controller 200, for example, via electrical wiring (not shown) provided on the main plate 301. In addition, the potential difference generated in the adhesion removal process can be larger than the potential difference generated in the adhesion suppression process.

### Effects

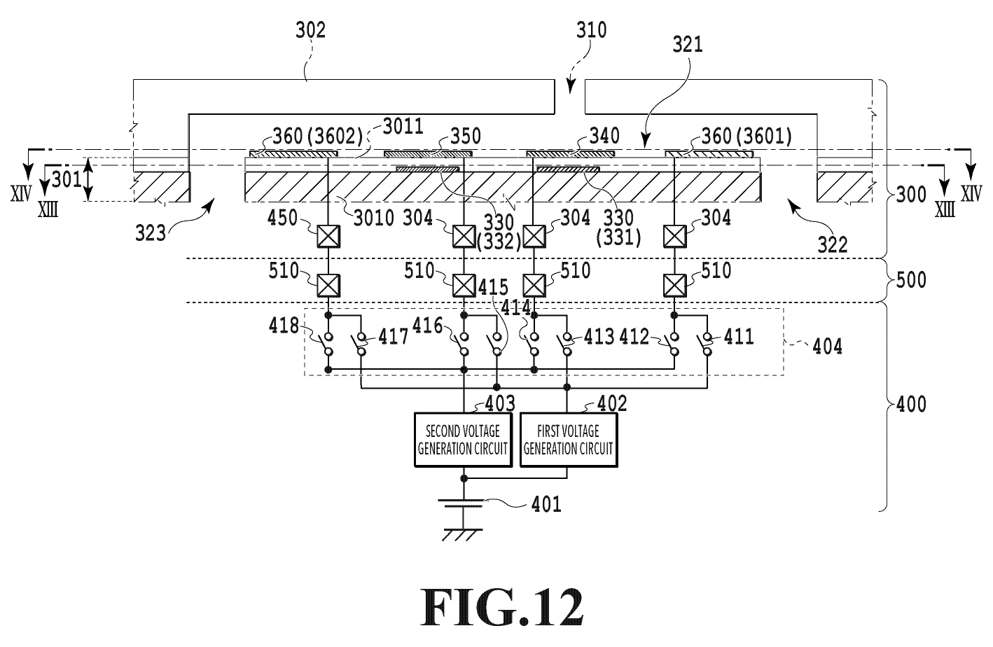

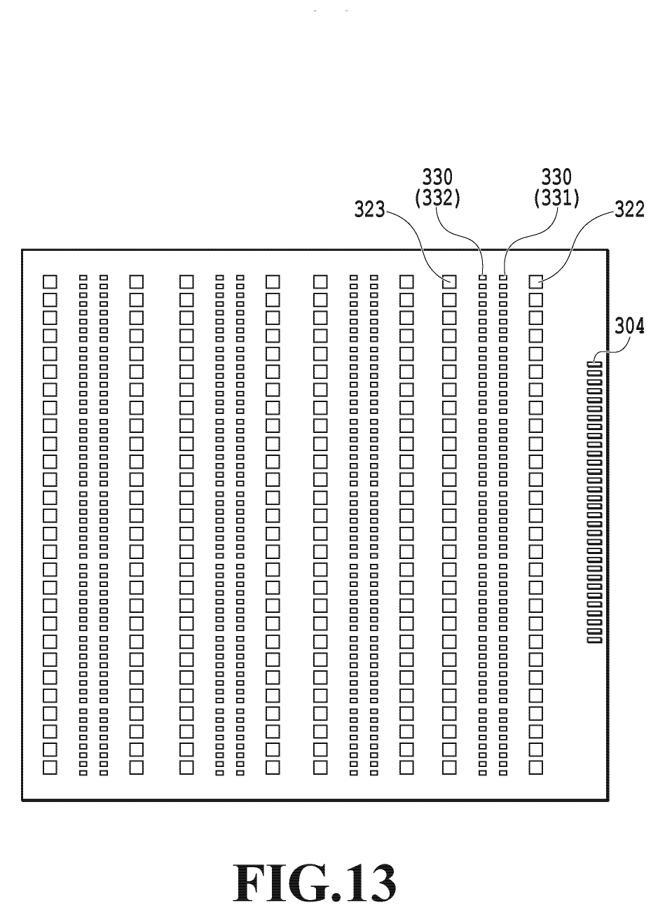

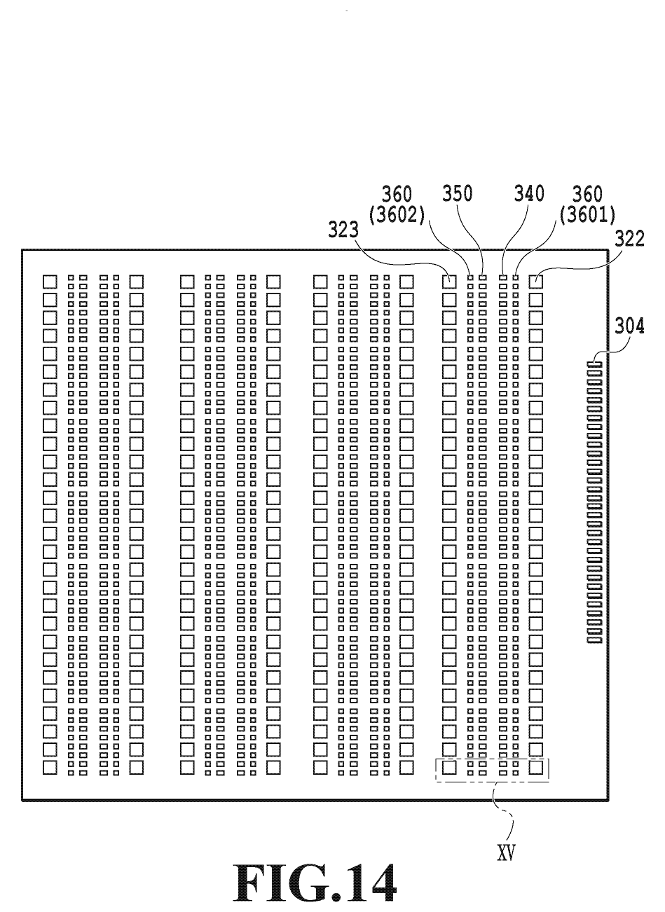

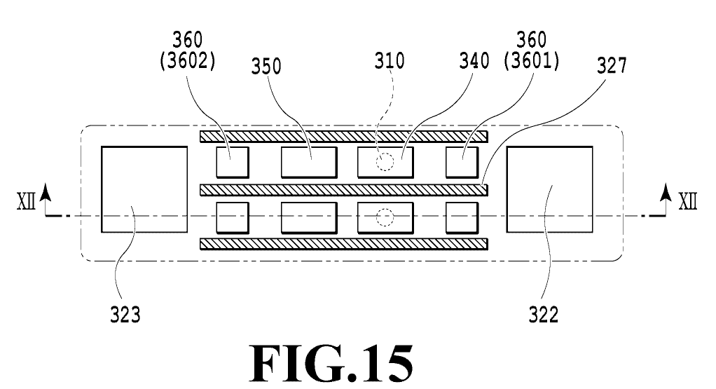

FIG. 12 is a diagram showing a comparative example corresponding to FIG. 4. FIG. 13 is a diagram showing the comparative example corresponding to FIG. 5. FIG. 14 is a diagram showing the comparative example corresponding to FIG. 6. FIG. 15 is a diagram showing the comparative example corresponding to FIG. 8.

As shown in FIGS. 12, 14, and 15, the comparative example differs from the first embodiment in that two opposing electrodes 360 are provided. One of the two opposing electrodes 360 is an opposing electrode 3601, which is used as a paired electrode of the first electrode 340. The other one of the two opposing electrodes 360 is an opposing electrode 3602, which is used as a paired electrode of the second electrode 350.

In the comparative example, in which a paired electrode is not used in common to the two electrodes, the area (chip area) of the liquid ejection board 300 increases compared to the first embodiment, in which a paired electrode is used in common to the two electrodes. This is also apparent from the comparison between FIGS. 13 and FIG. 5, the comparison between FIGS. 14 and FIG. 6, and the comparison between FIGS. 15 and FIG. 8. Thus, since this embodiment uses the opposing electrode 360 in common as a paired electrode of the first electrode 340 and a paired electrode of the second electrode 350, the area equivalent to one paired electrode in a case where a paired electrode is not used in common can be reduced substantially.

In addition, in the comparative example, in which a paired electrode is not used in common to the two electrodes, the number of switching devices for switching connections to the paired electrodes increases compared to the first embodiment, in which a paired electrode is used in common to the two electrodes. Specifically, a seventh switching device 417 that switches the connection between the opposing electrode 3602 and the first voltage generation circuit 402 and an eighth switching device 418 that switches the connection between the opposing electrode 3602 and the second voltage generation circuit 403 are added. This is also apparent from the comparison between FIGS. 12 and FIG. 4. In this way, since this embodiment uses the opposing electrode 360 in common as a paired electrode of the first electrode 340 and a paired electrode of the second electrode 350, the number of switching devices can be reduced compared to the case where a paired electrode is not used in common.

Furthermore, this embodiment performs control to generate a potential difference between the first electrode 340 and the opposing electrode 360 and between the second electrode 350 and the opposing electrode 360. This can suppress the adhesion of substances to the first electrode 340 and the second electrode 350 and also remove adhered substances adhering to the electrodes. As a result, the durability of the electrodes can be improved. In addition, the heat conduction from the electrothermal transducing elements 330 to ink can also be improved.

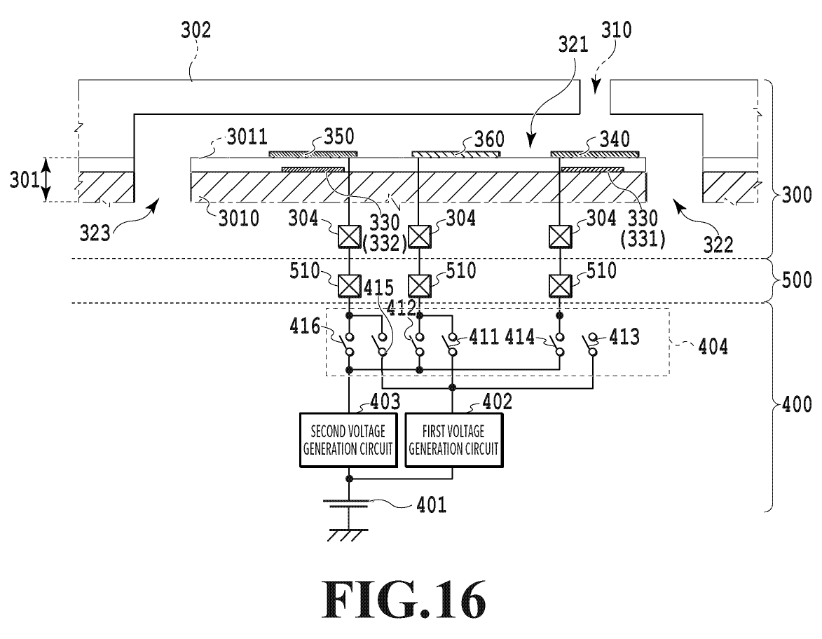

In the above embodiment, while the first electrode 340 is disposed between the opposing electrode 360 and the second electrode 350, the arrangement of the electrodes is not limited to this. FIG. 16 is a diagram showing an example of another arrangement of the electrodes in FIG. 4. In the example of FIG. 16, the opposing electrode 360 is disposed between the first electrode 340 and the second electrode 350. Even in this way, it is possible to obtain the same effects as the above effects.

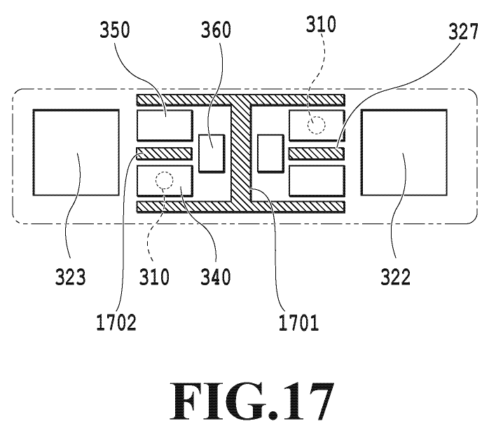

In addition, in the above embodiment, while the first electrode 340, the second electrode 350, and the opposing electrode 360 are arranged in a straight line in the direction of the ink flow, the arrangement of the electrodes is not limited to this. FIG. 17 is a diagram showing an example of another arrangement of the electrodes in FIG. 8. In the example shown in FIG. 17, the first electrode 340, the second electrode 350, and the opposing electrode 360 are arranged in a U-shape in the direction of ink flow. Specifically, the first electrode 340 and the second electrode 350 are disposed between the liquid collection channel 323 (or the liquid supply channel 322) and a first partition unit 1701. In addition, the opposing electrode 360 is disposed between the first partition unit 1701 and the first and second electrodes 340 and 350. In addition, a second partition unit 1702 is disposed between the first electrode 340 and the second electrode 350. The opposing electrode 360 is located between the second partition unit 1702 and the first partition unit 1701. Even in this way, it is possible to obtain the same effects as the above effects.

### Second Embodiment

### Overview

The first embodiment has described an example in which the opposing electrode 360 is used in common as a paired electrode of the first electrode 340 and a paired electrode of the second electrode 350. This embodiment will describe an example of using the first electrode 340 and the second electrode 350 in common. Note that the following description will omit the content common to that in the first embodiment as appropriate, and will mainly describe their differences.

### Configuration of Liquid Ejection Board

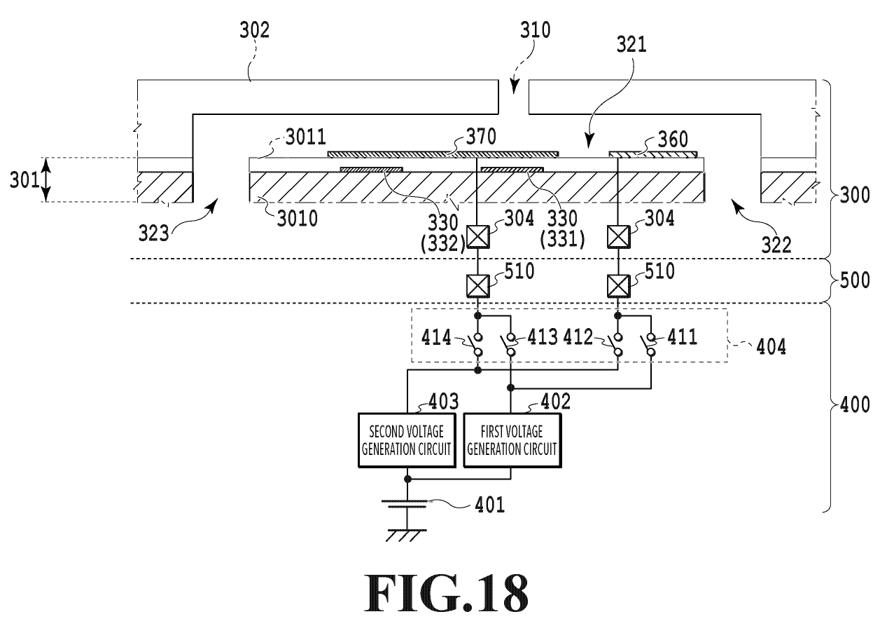

FIG. 18 is an example of the cross-section of a part of the liquid ejection board 300 in a second embodiment. FIG. 18 corresponds to FIG. 4, which shows an example of the cross-section of a part of the liquid ejection board 300 in the first embodiment.

In this embodiment, a common electrode 370 is used in place of the first electrode 340 and the second electrode 350 in the first embodiment. Although not shown, common electrodes 370 are provided for each ejection port row 311 along the extending direction of the ejection port row 311 at intervals.

The common electrode 370 is disposed on the surface of the main plate 301 in the liquid chamber and is in contact with the ink in the liquid chamber. The common electrode 370 is located closer to the ejection port 310 than the ejecting element 331 and the circulating element 332 in the first direction. The common electrode 370 includes a first part overlapping the ejecting element 331 in the first direction and a second part overlapping the circulating element 332 in the first direction. The common electrode 370 is disposed to cover each of the ejecting element 331 and the circulating element 332 located apart from the common electrode 370 in the first direction.

The common electrode 370 is a protective member that protects each of the ejecting element 331 and the circulating element 332, and has cavitation resistance. The common electrode 370 is also a member for suppressing the adhesion of substances to the electrodes as well as removing substances adhering to the electrodes.

In this embodiment, the opposing electrode 360 is used as a paired electrode of the common electrode 370, and is electrically connected to the common electrode 370 via ink. In a case of using the same material for the opposing electrode 360 and the common electrode 370, the opposing electrode 360 and the common electrode 370 can be formed in a common layer. In the example of FIG. 18, the opposing electrode 360 and the common electrode 370 are formed in a common layer. In this case, the electrodes can be formed in the same process.

### Circuit Configuration

The circuit unit 400 includes the power supply unit 401, the first voltage generation circuit 402, the second voltage generation circuit 403, and the switching unit 404 as in the first embodiment, whereas the configuration of the switching unit 404 is different from that in the first embodiment. That is, the number of switching devices included in the switching unit 404 is smaller than that in the first embodiment. The example of FIG. 18 does not include the fifth switching device 415 and the sixth switching device 416.

The first voltage generation circuit 402 and the second voltage generation circuit 403 are circuits that generate voltage based on power supplied from the power supply unit 401. The voltage generated by the first voltage generation circuit 402 is denoted by V1 [V]. The voltage generated by the second voltage generation circuit 403 is denoted by V2 [V]. V1 is larger than V2. In a case where the third switching device 413 and the second switching device 412 are set to on and the other switching devices are set to off, a potential difference occurs between the common electrode 370 and the opposing electrode 360. In this case, the potential of the common electrode 370 is higher than that of the opposing electrode 360. In addition, in a case where the fourth switching device 414 and the first switching device 411 are set to on and the other switching devices are set to off, a potential difference also occurs between the common electrode 370 and the opposing electrode 360. In this case, the potential of the common electrode 370 is lower than that of the opposing electrode 360.

### Control Processes

The adhesion suppression process and the adhesion removal process can be performed as control processes as in the first embodiment. The adhesion suppression process is performed while the electrothermal transducing elements 330 are heated. That is, in a case where the ejecting element 331 and the circulating element 332 are supplied with power, the controller 200 controls the switching unit 404 so that a potential difference occurs. In this case, for example, the voltage applied to the common electrode 370 is set to 0 [V], and the voltage applied to the opposing electrode 360 is set to 1 [V]. As another example, the voltage applied to the common electrode 370 is set to -0.3 [V], and the voltage applied to the opposing electrode 360 is set to 1 [V].

The adhesion removal process is performed while the electrothermal transducing elements 330 are not heated. That is, in a case where the ejecting element 331 and the circulating element 332 are not supplied with power, the controller 200 controls the switching unit 404 so that a potential difference occurs. In this case, for example, the controller 200 controls the switching unit 404 so that a potential difference occurs between the common electrode 370 and the opposing electrode 360. For example, the voltage applied to the common electrode 370 is set to 5 [V], and the voltage applied to the opposing electrode 360 is set to 0 [V].

### Effects

The common electrode 370 is shared as the first electrode 340 and the second electrode 350 in the first embodiment. This can not only substantially reduce the chip area compared to the comparative example, but also reduce the number of electrodes compared to the first embodiment. In addition, it is also possible to reduce the number of switching devices compared to the comparative example and the first embodiment.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, the number of parts can be reduced.

This application claims the benefit of Japanese Patent Application No. 2025-033596, filed March 4, 2025, which is hereby incorporated by reference herein in its entirety.

What is claimed is:

1. A liquid ejection board comprising:
an ejection port from which liquid is ejected;
a first electrothermal transducing element that is disposed to at least partially overlap the ejection port in plan view from a first direction and is disposed at a position different from the ejection port in the first direction;
a second electrothermal transducing element that is disposed without overlapping the ejection port in the planar view;
a first electrode that is located between the first electrothermal transducing element and the ejection port in the first direction;
a second electrode that is located closer to the ejection port than the second electrothermal transducing element in the first direction;
an opposing electrode that is used in common as a paired electrode of the first electrode and a paired electrode of the second electrode, and is electrically connected via liquid; and
a connection unit that electrically connects the first electrode, the second electrode, and the opposing electrode to an outside.

2. The liquid ejection board according to claim 1, further comprising:
a first plate; and
a second plate that is laminated on one surface of the first plate to form a liquid chamber with the first plate,
wherein the ejection port extends from a surface of the second plate to the liquid chamber, and
wherein the first electrothermal transducing element and the second electrothermal transducing element are disposed inside the first plate, and the first electrode, the second electrode, and the opposing electrode are disposed on the one surface of the first plate in the liquid chamber.

3. The liquid ejection board according to claim 1, further comprising at least one of a switching unit that is switchable between on and off of application of a potential difference or a voltage generation circuit that generates voltage.

4. The liquid ejection board according to claim 1, wherein an electrode surface of the first electrode in contact with liquid is made of a metal comprising iridium or ruthenium as a main component.

5. The liquid ejection board according to claim 1, wherein the first electrode and the second electrode are formed in a common layer.

6. The liquid ejection board according to claim 1, wherein the first electrode, the second electrode, and the opposing electrode are formed in a common layer.

7. A liquid ejection board comprising:
an ejection port for ejecting liquid;
a first electrothermal transducing element that is disposed to at least partially overlap the ejection port in plan view from a first direction and is disposed at a position different from the ejection port in the first direction;
a second electrothermal transducing element that is disposed without overlapping the ejection port in the planar view;
a common electrode that is located closer to the ejection port than the first electrothermal transducing element and the second electrothermal transducing element in the first direction, and includes a first part overlapping the first electrothermal transducing element in the first direction and a second part overlapping the second electrothermal transducing element in the first direction;
an opposing electrode that is electrically connected to the common electrode via liquid; and
a connection unit that electrically connects the common electrode and the opposing electrode to an outside.

8. The liquid ejection board according to claim 7, wherein the common electrode and the opposing electrode are formed in a common layer.

9. An inkjet recording apparatus comprising a liquid ejection board and a circuit unit that generates a potential difference between electrodes in the liquid ejection board,
the liquid ejection board comprising:
an ejection port from which liquid is ejected;
a first electrothermal transducing element that is disposed to at least partially overlap the ejection port in plan view from a first direction and is disposed at a position different from the ejection port in the first direction;
a second electrothermal transducing element that is disposed without overlapping the ejection port in the planar view;
a first electrode that is located between the first electrothermal transducing element and the ejection port in the first direction;
a second electrode that is located closer to the ejection port than the second electrothermal transducing element in the first direction;
an opposing electrode that is used in common as a paired electrode of the first electrode and a paired electrode of the second electrode, and is electrically connected via liquid; and
a connection unit that electrically connects the first electrode, the second electrode, and the opposing electrode to an outside.

10. The inkjet recording apparatus according to claim 9, wherein the circuit unit has a first process of generating a potential difference in a case where the first electrothermal transducing element and the second electrothermal transducing element are supplied with power and a second process of generating a potential difference in a case where the first electrothermal transducing element and the second electrothermal transducing element are not supplied with power.

11. The inkjet recording apparatus according to claim 9, wherein the potential difference generated in the second process is greater than the potential difference generated in the first process.
